(19) United States
(12) Patent Application Publication
(10) Pub. No.: US 2008/0288419 A1
(43) Pub. Date: Nov. 20, 2008

(54) Integrated trading and information system for collection and dissemination of valuation data

(75) Inventors: Douglas Miles, Princeton, NJ (US); Jacob Ginder, Watchung, NJ (US)

Correspondence Address: PATTON BOGGS LLP, 8484 WESTPARK DRIVE, SUITE 900, MCLEAN, VA, 22102, US

(73) Assignee: GLOBALPRIVATEQUITY.COM, INC., Princeton, NJ (US)

(21) Appl. No.: 12/153,311

(22) Filed: May 16, 2008

Related U.S. Application Data
(60) Provisional application No. 60/924,534, filed on May 18, 2007.

(51) Int. Cl. G06Q 40/00

(52) U.S. Cl. 705/36 R; 705/37

(57) ABSTRACT

Systems and methods are provided for a financial trading information processing and transmission system representing: (a) a financial business intelligence system (FBIS) which aggregates observable market inputs along with valuation algorithms or pricing models to generate synthetic or theoretical ‘fair values’ or prices (aka Level 2 prices as defined by the FAS 157, effective Nov. 15, 2007 or other measures of fair values); (b) a multilateral counterparty trade module, an auction module, a risk metric and analytical tool module, and optionally a derivative tracking module; or (c) a central data base of Level 2 or other desired price information used to provide bid and offer market intelligence at the point of trading or preparing to trade on any electronic system for specific assets or markets, which may not be actively yielding Level 2 or other desired price information or actual trades.

### RELATED APPLICATION

This patent application claims priority to U.S. provisional patent application Ser. No. 60/924,534, filed May 18, 2007, titled “Automated Trading Simulation System for Derivatives, Unregistered and Exempt Securities”, which is herein incorporated by reference its entirety.

### BACKGROUND

Fair value, price or valuation, is a concept used in finance, accounting and economics. Fair value may have a range of interpretations for application in the capital markets industry and may be arrived at in different ways. One method of defining fair value is set forth by the Financial Accounting Standards Board (“FASB”) as follows:
“This Statement clarifies that the exchange price is the price in an orderly transaction between market participants to sell the asset or transfer the liability in the market in which the reporting entity would transact for the asset or liability, that is, the principal or most advantageous market for the asset or liability. The transaction to sell the asset or transfer the liability is a hypothetical transaction at the measurement date, considered from the perspective of a market participant that holds the asset or owes the liability. Therefore, the definition focuses on the price that would be received to sell the asset or paid to transfer the liability (an exit price), not the price that would be paid to acquire the asset or received to assume the liability (an entry price).”

Fair value may be more generically defined as a rational and unbiased estimate of the potential market price of a good, service, or asset, taking into account such factors as: relative scarcity, perceived utility (economist's term for subjective value based on personal needs), potential risk/return characteristics (i.e., for a tradable asset), replacement costs, or costs of close substitutes, and production/distribution costs, including a cost of capital.

Under the efficient market hypothesis, in a well-organized, reasonably transparent market, the market price is generally equal to or close to the fair value, as investors react quickly to incorporate new information about relative scarcity, utility, or potential returns of their bids or offers. However, the prices of derivatives, distressed assets, unregistered and exempt securities are finalized on a periodic basis, rather than real-time as with listed stocks or bonds. As such, the participants (bidders or sellers) cannot obtain and rapidly incorporate new information about relative scarcity, utility, or potential returns in their bids for derivatives, unregistered and exempt securities.

In addition, regulators and accounting standards boards, such as the FASB, are focused on mandating independent fair value provisions in their directives and standards. The FASB is a private, not-for-profit organization whose primary purpose is to develop generally accepted accounting principles in the United States for the public interest. The SEC designated the FASB as the organization responsible for setting accounting standards for public companies in the United States. There may be a market wide rush to seek compliance. It is estimated that over 10,000 managers worldwide may be seeking fair value data on a range of unlisted products and OTC derivatives.

Two common measures of derivative value are: market price, i.e. the price at which traders are willing to buy or sell the contract; and arbitrage-free or the theoretical price, meaning that no riskless profits can be made by trading in these contracts. The arbitrage-free price for a derivatives contract is often complex, often with many different variables to consider. Arbitrage-free pricing is a central topic of financial mathematics. The stochastic process of the price of the underlying asset is often, but not always, crucial. A key equation for the theoretical valuation of options is the Black-Scholes formula, which is based on the assumption that the cash flows from a European stock option can be replicated by a continuous buying and selling strategy using only the stock. A simplified version of this valuation technique is the binomial options model. Arbitrage-free pricing techniques do play an important role in both creating and analyzing ‘fair value’ pricing as well as amounts of an asset to bid and or offer as a percentage of the total outstanding amount of the underlying product.

### SUMMARY

Certain embodiments of the integrated trading and information system may provide methods and/or systems having beneficial features that make them optimal for use in certain situations, such as more accurate synthetic asset and derivative valuation.

Embodiments may include a system for automated trading having a trading module for allowing one or more bidders and one or more offerors to communicate regarding one or more transactions for an asset, an auction module for allowing the one or more bidders and the one or more offerors to communicate regarding one or more auction deals for the asset, and a risk metric and analytical tool module for providing additional information regarding the asset.

Embodiments may also include a method for determining a synthetic fair value having the steps of aggregating one or more inputs corresponding to an asset type from one or more external databases of financial information, processing the one or more inputs corresponding to the asset type with one or more synthetic fair value models, generating a synthetic fair value for the asset type from the one or more synthetic fair values, and storing the synthetic fair value in a central database for dissemination to a user desiring the synthetic value for the asset type.

Embodiments may further include a system for providing a synthetic fair value having a central database comprising one or more synthetic fair values corresponding to one or more asset types, wherein the one or more synthetic fair values are used to provide bid and offer market intelligence in response to an inquiry during trading or prior to trading on an automated trading system for the one or more asset types, wherein the trading on the one or more asset types is not actively yielding actual trade information, and wherein the synthetic fair value enables asset price discovery at the time and date of the inquiry.

This Summary is provided to introduce a selection of concepts in a simplified form further described below in the detailed description. This Summary is not intended to identify key features or essential features of the claimed subject matter, nor is it intended to be used as an aid in determining the scope of the claimed subject matter. Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate the invention and together with the detailed description serve to explain the principles of the invention. In the drawings:

FIG. 1 is an exemplary flow diagram of a system home page, according to one embodiment.

FIG. 2 is an exemplary schematic of system architecture, according to one embodiment.

FIG. 3 is an exemplary flow diagram of an analytic module home page, according to one embodiment.

FIG. 4 is an exemplary flow diagram of a trade module home page, according to one embodiment.

FIG. 4A is an exemplary flow diagram of a bid/offer discovery page, according to one embodiment.

FIG. 4B is an exemplary flow diagram of an individual's bid/offer page, according to one embodiment.

FIG. 4C is an exemplary flow diagram of market bids/offers page, according to one embodiment.

FIG. 4D is an exemplary flow diagram of a deal directory page, according to one embodiment.

FIG. 4E is an exemplary flow diagram of a search page, according to one embodiment.

FIG. 4F is an exemplary flow diagram of an administration page, according to one embodiment.

FIG. 4F1 is an exemplary flow diagram of user administration page, according to one embodiment.

FIG. 4F2 is an exemplary flow diagram of an entity subscriber preference page.

FIG. 4F3 is an exemplary flow diagram of an entity subscriber authorization page, according to one embodiment.

FIG. 4F4 is an exemplary flow diagram of a user buy/sell preferences page, according to one embodiment.

FIG. 4F5 is an exemplary flow diagram of user notification preferences page, according to one embodiment.

FIG. 5 is an exemplary flow diagram of a notification function, according to one embodiment.

FIG. 6 is an exemplary flow diagram of an acceptance function, according to one embodiment.

FIG. 7 is an exemplary flow diagram of an end of day function, according to one embodiment.

FIG. 8 is an exemplary flow diagram of a login function, according to one embodiment.

FIG. 9 is an exemplary flow diagram of a logoff function, according to one embodiment.

FIG. 10 is an exemplary flow diagram of an auction module, according to one embodiment.

FIG. 10A is an exemplary flow diagram of an auction price function, according to one embodiment.

### DETAILED DESCRIPTION

### Definitions

To more clearly and concisely describe the subject matter of the claims, the following definitions are intended to provide guidance as to the meanings of specific terms used in the following written description. Also, it is to be understood that the phraseology or terminology employed herein is for the purpose of description and not of limitation. As used herein:

“Exempt securities” are instruments exempt from the registration requirements of the Securities Act of 1933 or the margin requirements of the SEC Act of 1934. Such securities include government bonds, agencies, munis, commercial paper, and private placements. The official definition of securities under the Securities Exchange Act of 1934 is:

“Any note, stock, treasury stock, bond, debenture, certificate of interest or participation in any profit-sharing agreement or in any oil, gas, or other mineral royalty or lease, any collateral trust certificate, pre-organization certificate or subscription, transferable share, investment contract, voting-trust certificate, certificate of deposit, for a security, any put, call, straddle, option, or privilege on any security, certificate of deposit, or group or index of securities (including any interest therein or based on the value thereof), or any put, call, straddle, option, or privilege entered into on a national securities exchange relating to foreign currency, or in general, any instrument commonly known as a ‘security’; or any certificate of interest or participation in, temporary or interim certificate for, receipt for, or warrant or right to subscribe to or purchase, any of the foregoing; but shall not include currency or any note, draft, bill of exchange, or banker's acceptance which has a maturity at the time of issuance of not exceeding nine months, exclusive of days of grace, or any renewal thereof the maturity of which is likewise limited.”

This may further include a category of alternative products called structured products which are loan or debt-like instruments comprised of other loans, notes, mortgages, bonds, or derivatives and called by names such as CDOs for collateralized debt obligation or CLOs for collateralized loan obligations or CMOs for collateralized mortgage obligations.

A “derivative” is a financial instrument/contract derived from the performance of assets, interest rates, currency exchange rates, or indexes; rather than trade or exchange of the asset itself, market participants enter into an agreement to exchange money, assets or some other value at some future date based on the underlying asset. Derivative transactions include a wide assortment of financial contracts including structured debt obligations and deposits, swaps, futures, options, caps, floors, collars, forwards and various combinations thereof. Derivatives can be based on different types of assets such as commodities, equities or bonds, interest rates, exchange rates, or indices (such as a stock market index, consumer price index (CPI)—inflation derivatives—or even an index of weather conditions, or other derivatives).

A “derivative” of the invention includes over-the-counter (“OTC”) derivatives, exchange-traded derivatives, and common contract types of derivatives, which are not generally transactable via any real-time transaction exchange.

Over-the-counter (OTC) derivatives are contracts that are traded (and privately negotiated) directly between two parties, without going through an exchange or other intermediary. Products such as swaps, forward rate agreements, credit or property derivatives, and exotic options are generally traded over-the-counter. Complications can arise with an OTC or a floor-traded contract, as trading is handled manually, making it difficult to automatically broadcast prices. In particular with OTC contracts, there is no central exchange by which to collate and disseminate prices.

“Exchange-traded derivatives” are those derivatives products that are traded via specialized derivatives exchanges or other exchanges. A derivatives exchange acts as an intermediary to all related transactions, and takes initial margin from both sides of the trade to act as a guarantee. The world's largest derivatives exchanges (by number of transactions) are the Korea Exchange (which lists KOSPI Index Futures & Options), Eurex (which lists a wide range of European products such as interest rate & index products), Chicago Mercantile Exchange and the Chicago Board of Trade. Some types of derivative instruments also may trade on traditional exchanges. For instance, hybrid instruments such as convertible bonds and/or convertible preferred may be listed on stock or bond exchanges. Also, warrants (or “rights”) may be listed on equity exchanges. Performance rights, Cash xPRT™ instruments, and various other instruments that essentially consist of a complex set of options bundled into a simple package are routinely listed on equity exchanges. Like other derivatives, these publicly traded derivatives provide investors access to risk/reward and volatility characteristics that, while related to an underlying commodity, nonetheless are distinctive. For exchange traded derivatives, market price is usually transparent (often published in real-time by the exchange, based on all the current bids and offers placed on that particular contract at any one time).

There are three major classes of derivatives:

(1) Futures/Forwards, which are contracts to buy or sell an asset at a specified future date.

(2) Options, which are contracts that give the buyer the right (but not the obligation) to buy or sell an asset at a specified future date. Options may also be referred to by the descriptor of warrants with the understanding that certain option conventions or features may at times be absent from certain warrants.

(3) Swaps, involve a contract where the two parties agree to exchange cash flows, one set of these based upon the underlying asset or derivative market of the swap with the other set based upon the relevant interest rate plus a margin tied to the underlying swap market's yield curve and currency. Swaps and warrants shall be considered part of the involved category of products covered by the present invention.

A “bid” of the present invention is a price offered by a buyer/bidder when trying to buy derivatives, unregistered and exempt securities, etc according to the present invention. The bid stands in contrast to the ask price or “offer”, and the difference between the two is called the bid/offer spread. An unsolicited bid or offer is when a person or company receives a bid even though they are not looking to sell. In the context of trading according to the present invention, the bid is the highest price or other prices set according to the “Auction” as defined as follows that a buyer is willing to pay for a share of derivatives, unregistered and exempt securities, etc according to the present invention.

An “auction” of the present invention is the process of buying and selling things by offering them up for bid, taking bids, and then selling the item to the winners based upon different rules as described as follows. English auctions are commonly used by the English auction houses like Sotheby's. Participants bid openly against one another, with each bid being higher than the previous bid. The auction ends when no participant is willing to bid further, or when a pre-determined “buy-out” price is reached, at which point the highest bidder pays the price. The seller may set a ‘reserve’ price and if the auction fails to have a bid higher than the reserve, the item remains unsold. Major auction houses include Christie's, Sotheby's, Lyon & Turnbull and Bonhams. Internet auctions such as Ebay and Bidsouth.com have become very popular. Chinese auction is basically a raffle. Dutch auction begins with a high asking price which is lowered until some participant is willing to accept the auctioneer's price, or a predetermined minimum price is reached. That winning participant pays the last announced price. The Dutch auction is named for its best known example, the Dutch tulip auctions. (“Dutch auction” is also sometimes used to describe online auctions where several identical goods are sold simultaneously to an equal number of high bidders. Economists call the latter auction a multi-unit English ascending auction). Sealed-bid first-price auction, aka “sealed high-did auction” or “first-price sealed-bid auction” (FPSB). In this type of auction all bidders simultaneously submit bids so that no bidder knows the bid of any other participant. The highest bidder pays the price they submitted. Sealed-bid second-price auction, also known as a Vickrey auction: This is identical to the sealed first-price auction, except the winning bidder pays the second highest bid rather than their own. This is very similar to the system used by eBay. All-pay auction: an auction in which all bidders must pay their bids regardless of whether they win the prize. The highest bidder wins the prize. The all-pay auction is often used to model lobbying (bids are political contributions), or other competitions.

### Overview

Needs exist for establishing a fair value immediately before or after a transaction of an alternative derivative, private equity fund, market indices, distressed debt instrument, and global money market or fixed income instrument or derivative product. Large hedge funds, bond dealers, or investment management companies and pension find holdings of these derivatives totaling trillions of dollars have almost no reliable method of achieving efficient price discovery on demand and/or risk metrics both being correctly valued let alone via an automated solution. There is currently no solution set representing a move towards standardization, automation, and fair price bid/offer market of specific derivative values and/or secondary market prices combined with risk analysis in these enormous and sometimes less liquid markets.

Key elements of the recently implemented FASB Rule 157 (“FAS 157”) governing fair value accounting of alternative or less liquid assets include the following concepts. The standard establishes a fair value hierarchy which prioritizes the inputs to valuation techniques used to measure fair value into three broad levels. Level 1 is the highest level and consists of quoted prices in active markets for identical assets or liabilities. Level 2 measurements involve quoted prices for similar assets or liabilities in active markets or quoted prices for identical or similar assets or liabilities in markets that are not active. Level 3 measurements are based on unobservable inputs. Level 3 asset fair value measurements create the most challenge and difficulty for user/participants. These values are derived from largely unobservable inputs. However, an asset or liability value that falls into Level 3 does not necessarily mean that all of the inputs involved in deriving the fair value figure are unobservable.

FAS 157 states: “In some cases, the inputs used to measure fair value might fall in different levels of the fair value hierarchy. The level in the fair value hierarchy within which the fair value measurement in its entirety falls shall be determined based on the lowest level input that is significant to the fair value measurement in its entirety.”

This means fair value for a particular asset or liability could be based on a mix of Level 1, Level 2, and Level 3 inputs. The asset or liability could fall completely into Level 3 if one of those inputs was deemed significant. Second, note that many of these assets and liabilities may have already been carried at fair value prior to the adoption of FAS 157. Corporate managers may have previously been valuing some of these assets and liabilities using internal models with unobservable inputs. FAS 157 offers better detail about how much of the assets and liabilities fall into the different levels of the fair value hierarchy.

Furthermore, the generally accepted accounting principles (“GAAP”) accounting framework not only allows, but often requires, the use of estimates and assumptions when preparing financial data. Accounting for pensions, employee stock options, and loan loss reserves are just some of the many areas where estimates play an important role in the accounting. Even something as basic as straight line depreciation involves the use of multiple estimates. There are four elements to a straight line deprecation calculation. Only one of the four, the original cost, is known. The other three, the choice of the depreciation method, the useful life, and the salvage value are all based on management assumptions. Use of estimates and assumptions has long been embedded into numerous areas of the GAAP accounting framework.

Generally, needs exist for improved methods and systems for more accurate synthetic asset and derivative valuation.

### The Integrated Trading and Information System

The integrated trading and information system for collection and dissemination of valuation data relates to an analytics and price discovery platform for less liquid markets and/or organized risk management/valuation analytics systems for alternative or structured products or indices. The analytics and price discovery platform may be connected to an electronic transaction system or simulated bid/offer system for achieving price/value indications in any market.

An aspect of an electronic transaction system or simulated bid/offer system may be price/value data collection, Level 2 or other forms of data synthesis, and related data dissemination regarding financial assets, indices, property, and/or credit derivatives. This may include bid-to-offer indications for unregistered and exempt securities, indices, derivatives, and/or over the counter trading and valuation information processing.

The integrated trading and information system may also include a transmission system for conducting both synthetic price discovery in less liquid markets, as well as supporting actual completed Level 1 electronic transactions, and, alternatively, tracking derivative, unregistered and exempt securities involving bid/offer indicative markets resulting in no trades or executions, all executable on a global information network.

More particularly, the integrated trading and information system is directed to a financial trading information processing and transmission system representing (a) a financial business intelligence system (“FBIS”) for aggregating observable market inputs to generate a synthetic fair value for a particular asset; (b) a multilateral counterparty trading system including a trading module and an auction module; and/or (c) a central database of Level 2 or other forms of price information for providing value information used during various types of trades.

As indicated above, the FBIS may aggregate observable market inputs along with valuation algorithms or pricing models to generate synthetic or theoretical fair values/prices, which may be Level 2 prices as defined by the FAS 157, effective Nov. 15, 2007 or another measure of fair value. A pricing model for fixed income assets or loans may employ an annual discounting from the assets' maturity to present time of the coupon or interest payment derived cash flows of the given instrument. The valuation of an option or a warrant related to an underlying instrument may involve the application of an accepted options pricing tools such as the Black Scholes model accompanied by the inputs of current volatility of the market (as expressed in a mean of the standard deviation of the asset's or market's price movement during the last 30 days), the desired striking price of the option as measured from above or below the current market level, the local interest rate, and/or the most recent value of the underlying cash market instrument for which the call or put option price is being created. A simple credit instrument valuation model may include deriving and quantifying three factors such as a (a) price or yield spread comparison to two comparable debt instruments, (b) a comparison of financial balance sheet ratios to one or more comparable business names, and (c) a comparison of earnings ratios or operating margins in the businesses being compared to those of the asset in question. These factors may then be assigned a series of weights adding to one hundred percent for purposes of generating a final output or answer based upon the sum of the weighted measures or factors. There may be an almost unlimited number of approaches and methods to synthesizing the price of an asset or derivative product as contemplated by the integrated trading and information system.

The multilateral counterparty trading system may include a trade module, an auction module, a risk metric and analytical tool module, and optionally a derivative tracking module.

The risk metric/analysis module may be used for entering or retrieving any analytic or conditional judgment or input on a single asset or derivative, an asset or derivative structure, or a portfolio of assets or derivatives that impacts the desired modeled outcome of values given the conditions chosen influencing the inputs. Such inputs may include, but are not limited to, the following list: Asset Backed Securities loan prepayment rates or payment delinquency rates; high yield loan or bond default rates; loan to value ratios of assets in question; debt service coverage ratios; widely followed ratings levels or credit tiers determined by NSROs (national statistical and research organizations such as Moody's, S&P, and Fitch Ratings) or other third parties; Level 1 yield spreads of any ABS or other debt assets to different ABS or debt assets, volatility levels of various assets or derivatives concerned, RAROC or risk adjusted return on capital calculations for assets concerned; recovery rate or liquidation value expectations of various assets; macro-economic influences by region or country such as inflation rates, growth rates, interest rates, trade balances, wholes sale input vs. output costs; adjusted duration measurements of specific assets; exchange rates impacting assets; asset or derivatives market correlations to broad market indices or to other related futures and derivative markets; or even the state of the overall economic cycle or the political or legal conditions in the nation of origin of the assets in question.

Upon the entry of whatever selection of model input data as described above has been deployed, the valuation module or the risk management module may compute, through a single or a series of fixed or conditional algorithms, the recommended solution or the desired output for the user to guide the user in a final decision or asset review or deployment question.

The auction module and the trade module may be particularly configured for conducting interactive online trading in derivatives, unregistered and exempt securities or indices that allows participants (i.e., bidders or offerors) to simulate bids or offers prior to actual bids or offers, to simulate bids or offers immediately after the actual bid, or offer for purposes of gaining price value indications only. This may also permit users to modify or withdraw their bids up to a certain point prior to acceptance by the seller, and sellers to withdraw their offers prior to a certain point.

The central database of Level 2 or other price information may be used to provide bid and offer market intelligence at the point of trading or preparing to trade on any electronic system for specific assets or markets, which may not be actively yielding Level 2 price information or actual trades. This same synthetic price information may also be employed for the purpose of enhancing asset price discovery or demonstrating or producing fair market value at the time and date of market inquiry or proposed transaction.

The integrated trading and information system may provide more accurate synthetic asset and derivative valuation. This may then provide the user or market participants with a user influenced reference for synthetic valuation. The platform data content may then guide and inform actual and legally committed bids and offers in products prior to real transactions occurring.

The integrated trading and information system improves upon current methods of capturing and differentiating current or recent price related trading of asset information in exempt securities, unlisted assets, illiquid derivatives and/or indices contracts—be it Level 1, Level 2, or Level 3 price or value information. The integrated trading and information system may provide full digital sourcing, delivery, reporting and archiving for such information for all derivatives, unregistered and exempt securities, indices, alternative and exempt assets.

The integrated trading and information system may also provide a major platform for transacting global unlisted assets or derivatives or indices markets by providing on demand, synthetic Level 2 fair value data from a remote database when none exists. Such Level 2 data may be derived from algorithms and formulas using observable market inputs, as well as relative value measures to similar or like assets, to project or hypothesize what the price would be if a trade occurred at the moment of inquiry.

Such on demand Level 2 data requested at a given moment may be presented alongside an historic or more than twenty four hour old Level 1 price of the given asset or contract. This standard of comparison for types of price data in alternative assets or derivative markets of a similar less liquid or infrequently traded character has become a cornerstones of the November 2007 inaugurated FASB Rule 157 on fair value accounting. This Level 2 fair value data may appear immediately on the screen or a user interface prior to or immediately after an actual electronic buy or sell transaction in one of the alternative products, indices, or less liquid assets markets. The Level 2 fair value data may be accompanied by both the date and time of creation of the Level 2 price as well as by the date and time of the most recent historical Level 1 price of the particular transaction or asset/contract involved.

The integrated trading and information system may incorporate presentation and delivery of Level 2 price data from logical, transparent and straightforward valuation models using observable market inputs from a range of sources.

Observable market inputs herein may include Level 1 transaction data emanating from sister markets or markets in which a traditional analytic metric is found. Such an example might be the Level 1 yield spread of a corporate bond to a government bond of like maturity or the level of volatility on average over the last 30 days for Market A when compared to Market B. The word observable may require that the inputs are observable and measurable by someone or some legitimate source other than the entity claiming the data observation for use as its valuation or risk measurement metric in computing fair value. The sources of such data may be major financial or risk management research and data firms such as Reuters, Bloomberg, Risk Metrics, Bear Measurisk, Standard & Poor's or publicly offered data of major central banks or government agencies, the U.S. Treasury, the Organisation for Economic Co-operation and Development (OECD), and the ticker plants of major exchanges or bourses, shipments, profits, balance sheet ratios, or sales activity data of certain companies whose issued securities or loans are under scrutiny in the decision making or valuation model may be observable inputs as well provided the sources of these data are arm's length and verifiable firms or organizations without inherent conflicts.

The integrated trading and information system may often consider complex relative value relationships among securities, indices, contracts, and unlisted products and derivatives of all asset classes. Complex relationships described herein may resemble an options theory based comparison of price movement between the derivative product and its cash market counterpart involving the analysis of delta or theta, which are, respectively, the rate of change in value of the derivative product based upon a corresponding move of the cash market asset versus the time value of money in the given option or the rate of value decay when viewed from the numbers of days to option expiry. This may involve calculus or quadratic equations being applied to generate such answers. Stochastic calculations involving a credit derivative contract and its price correlation between that contract and the underlying or corresponding corporate bond due to jump risk may be another such example as may be the multiplier or discounting effect of an observable macro-economic input like inflation, GDP growth or industrial production when arithmetically imposed upon the forecasted rising or falling of an asset's yield or dividend.

The valuation models supporting the information system of the integrated trading and information system may include both qualitative and quantitative based judgments, observable market data algorithms, and variables to provide users the most normalized and defensible Level 2 fair values data, which again meet FASB & GAAP parameters for replicability and transparency. The judgments may encompass a wide range of considerations from sensitivity to credit market benchmarks, to targeted levels of corporate earnings or free cash flows, to market or issuer fundamentals, to macro-economic variables applied in a given country or system to high growth or no growth conditions. The algorithms or formulae may be used to augment or leverage the effect of any change in the targeted variables or input so as to allow the system to reveal what may happen to the overall asset price or type of price behavior under specified conditions set forth by the variables or inputs. Weighting or prioritizing of one algorithm or model factor versus others may aid in increasing the precision level or relevance of the desired model output. Eliminating some variables over others in differentiated market conditions or comparisons may also serve to improve the accuracy and quality of the desired model output. Judgments may be a way for a user or modeler to control or qualify the model or decision making inputs, which in turn may control the character and level of the model output.

The integrated trading and information system may provide a unique data aggregation point and database aggregation role delivering both actual Level 1 price data as well as synthetic fair value or Level 2 price data for alternative or unlisted products.

The integrated trading and information system may provide deferred and/or simulated bidding and offering an environment unrestricted by local business hours or physical proximity.

The integrated trading and information system may cross reference or use Level 1 and Level 2 data on similar or like products as the user may wish to trade or price as a mechanism of allowing quick reference to comparable prices, both Level 1 and Level 2, of similar assets, contracts, or indices. This cross reference may allow buyers and sellers to quickly and efficiently evaluate, analyze and price all offerings on a common system. The common system may also utilize actual market price data being created by that system or other systems linked electronically to the common system.

The integrated trading and information system may support a higher quality standard for fair value or Level 2 price of unlisted assets, indices, or alternative products. Both a synthetic and transparent routine market to market valuation process for non-traded alternative assets may be required by such a standard.

The integrated trading and information system may provide a seller the ability to consider a plurality of synthetic bids submitted by bidders within a reasonable time frame and to concurrently participate in a synthetic bidding and offering activity.

In the integrated trading and information system, a buyer or seller may log on in a computer enabling network environment, and may be presented with an inventory screen listing product information and Level 2 price indications for a particular market and the date and origin of the data. A customer that desires to bid or offer may then be taken electronically to a bid or buyer's workstation menu to participate in the online trading process. This bid workstation may list all products available in the specified class of securities, assets, contract, or indices for which trading is desired.

The integrated trading and information system may provide a system that functions like an independent purchasing agent for buyers so as to maintain the buyer's identification confidential. Confidentiality may also allow for obtaining independent price information or synthetic price data without the influence of the buyer's business, i.e., at the lowest possible prices. The purchasing agent function of the integrated trading and information system may oversee the process of acquiring derivatives, unregistered and exempt securities by asking for bids, consulting with potential sellers, and reviewing bids and price quotations. Once this information is gathered, the integrated trading and information system may send bid levels to the buyers or offer levels to the sellers. The integrated trading and information system may then process the purchases or sales or the information may be used the buyers for use in their actual OTC transaction medium. This may automate a purchasing agent function to assist traders and investors in performing an arm's length and independent market check for price/value prior to entering into a trade with a given party or source or system for a less liquid or thinly traded asset or derivative.

The integrated trading and information system may provide systems and methods for more accurate synthetic asset and derivative valuation. The integrated trading and information system may be embodied in a software system that permits remote access by users. Users may access a system remotely through a system home page.

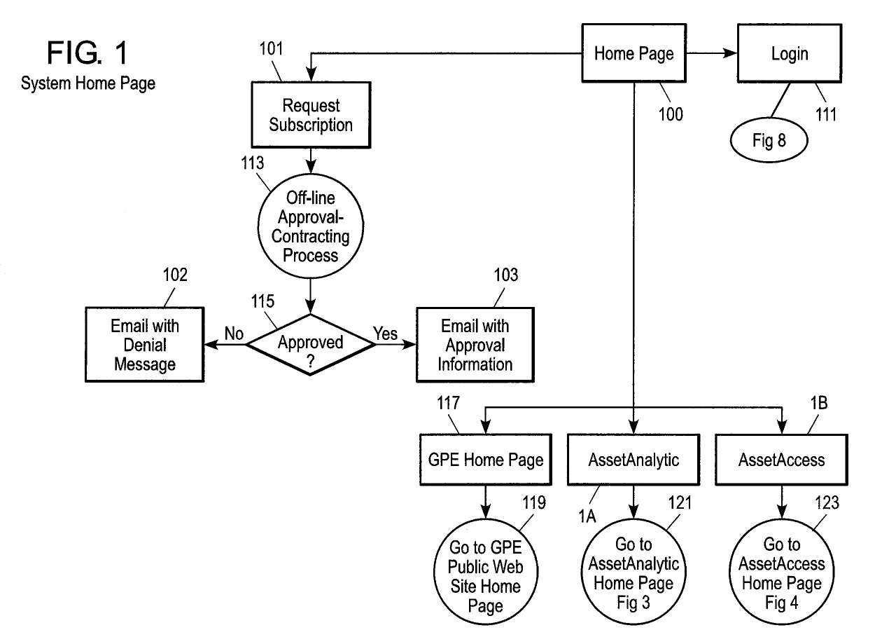

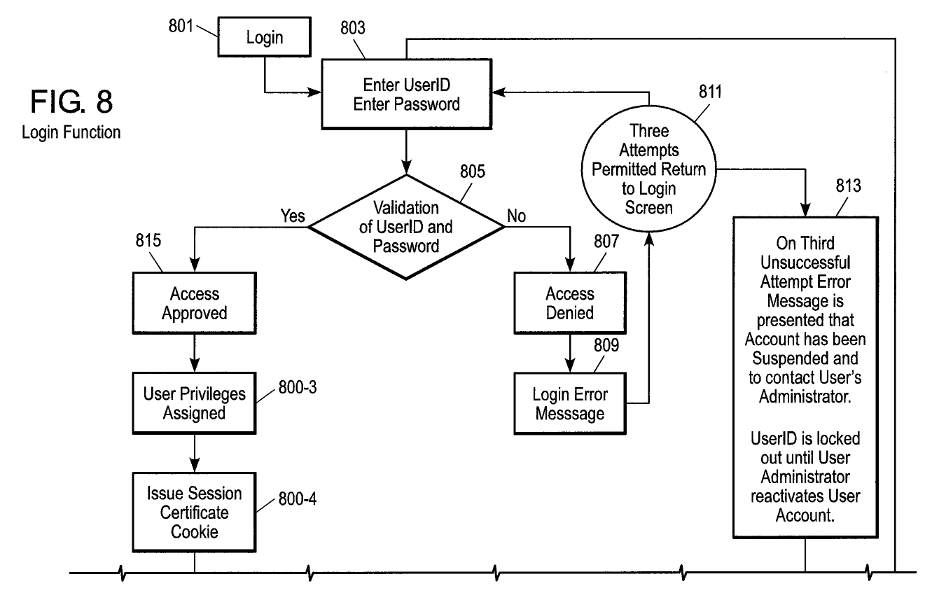

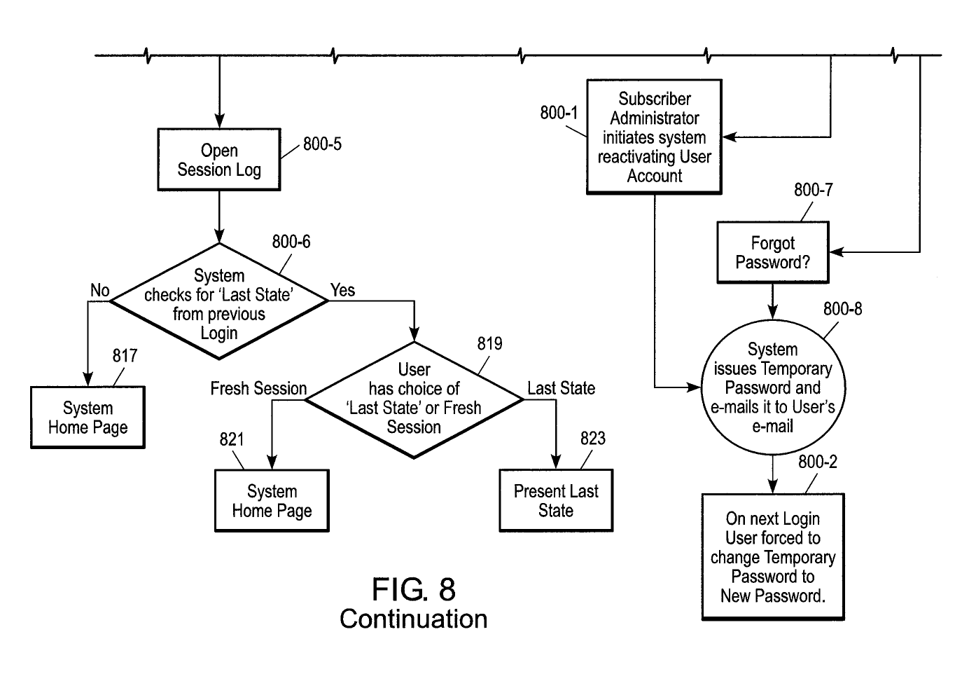

FIG. 1 is an exemplary flow diagram of a system home page. A user may access a homepage 100 via a web browser or similar method. The user may be prompted to login 111. The login process is described in more detail at FIG. 8. Alternatively, the user may be directed to request a subscription 101. An offline approval and/or contracting process 113 may be contacted for approval 115. If approved, an email with approval information 103 may be sent. If not approved, an email with a denial message 102 may be sent.

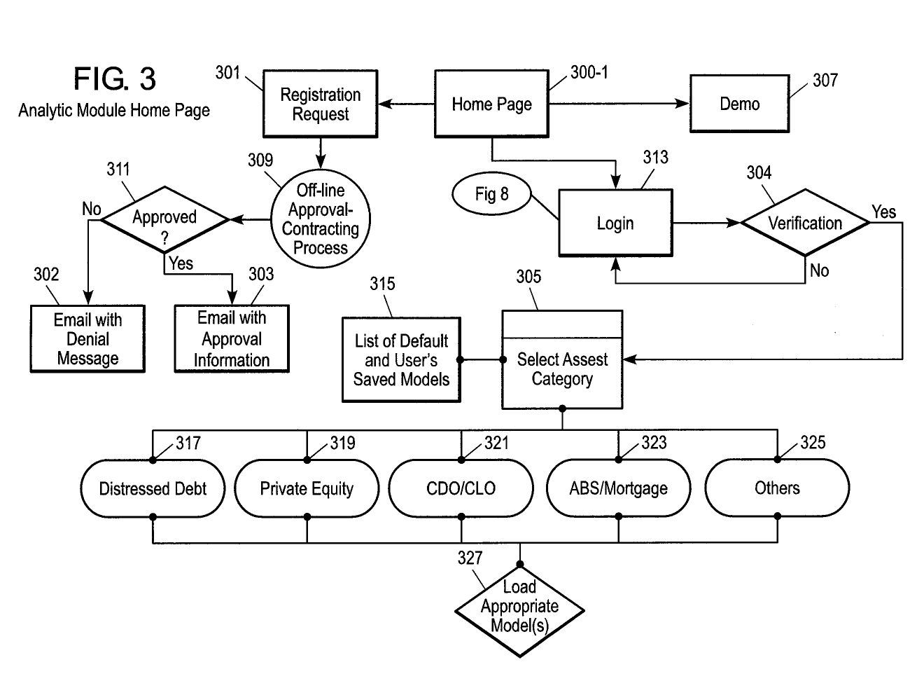

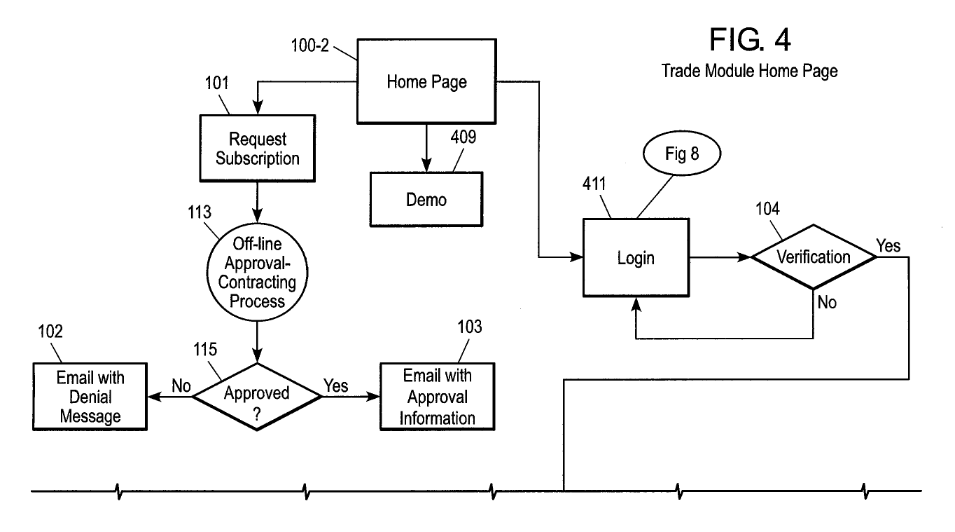

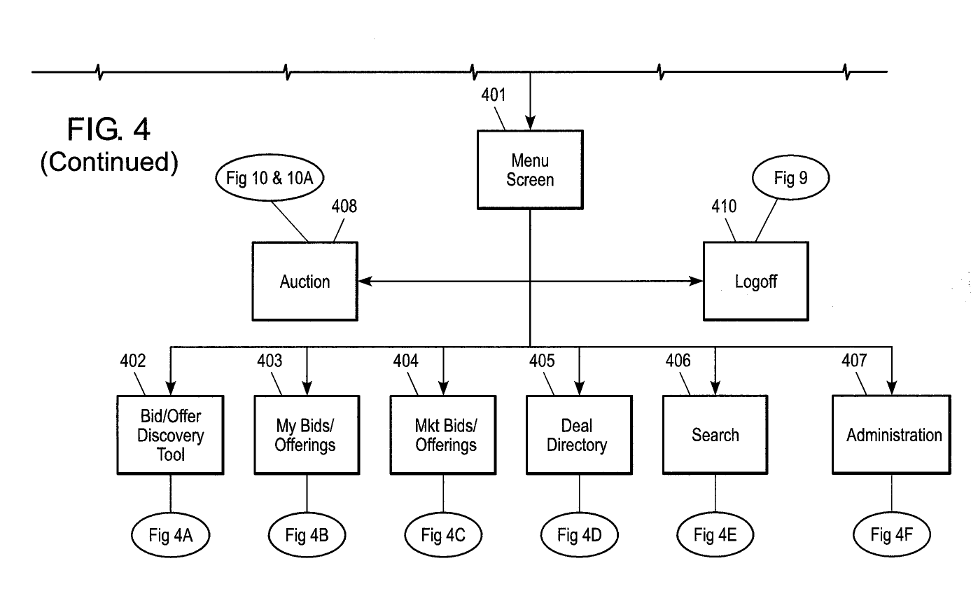

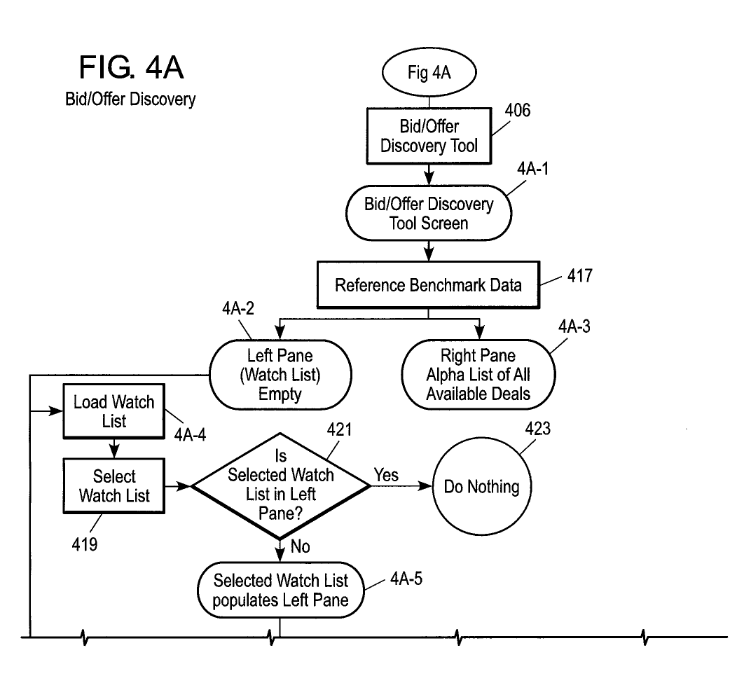

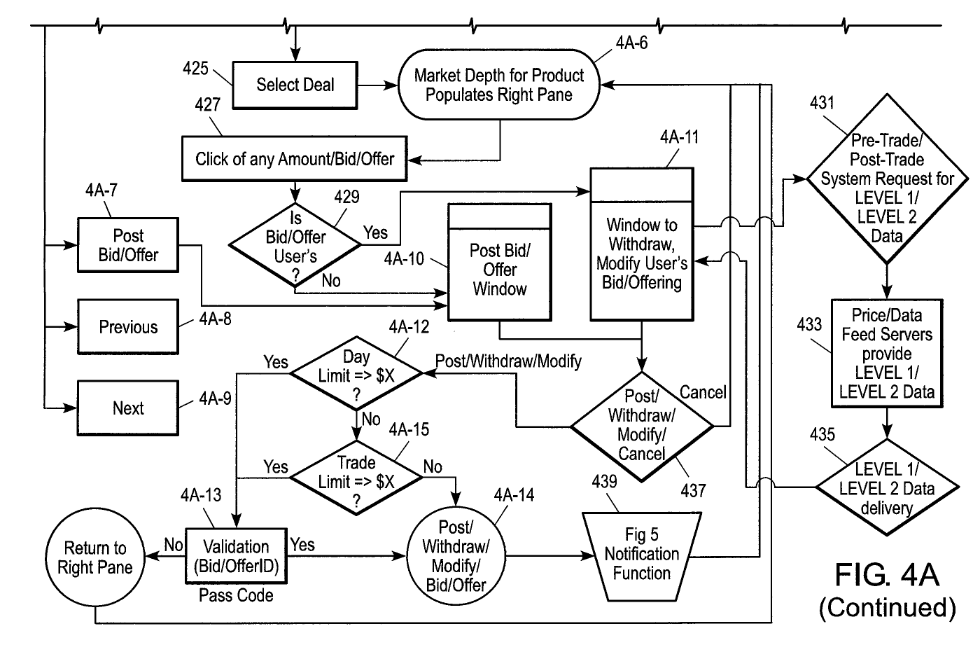

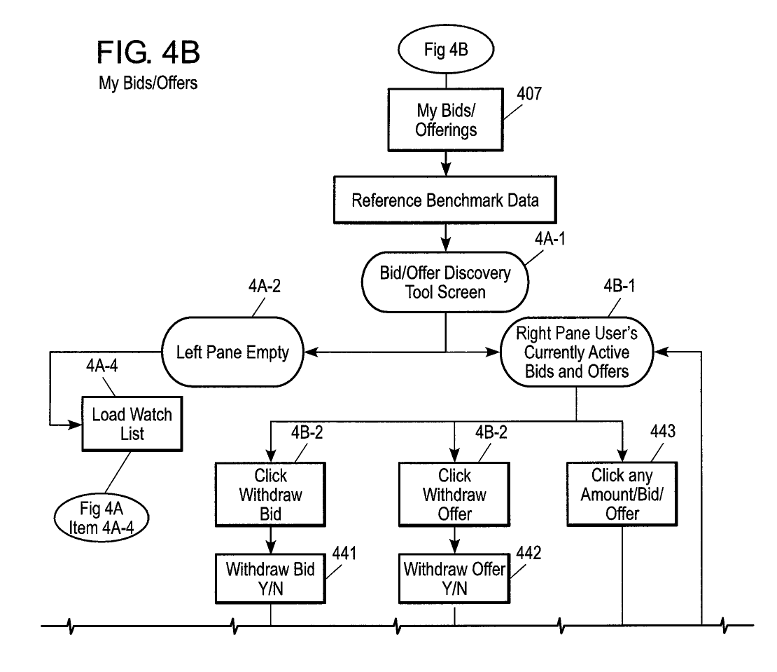

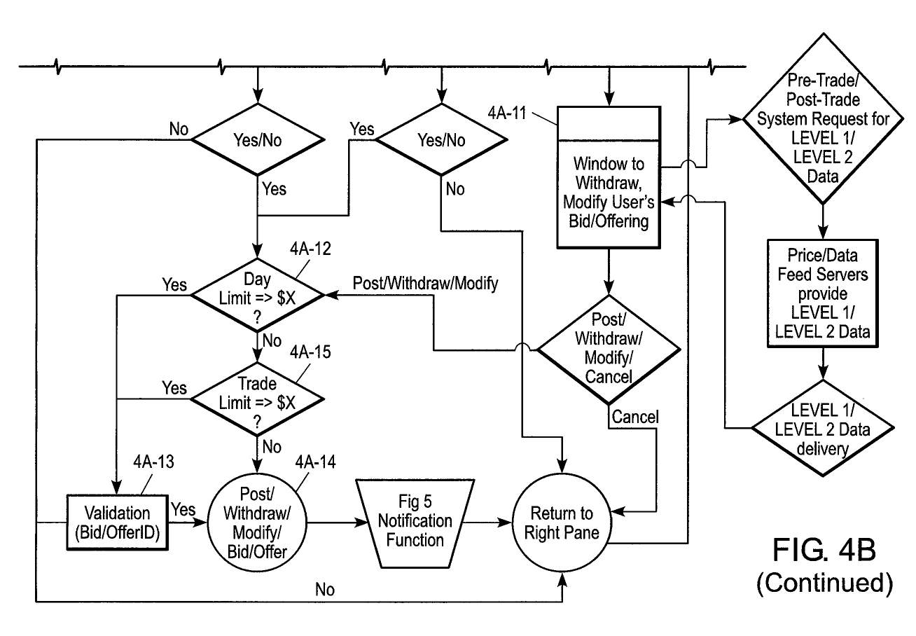

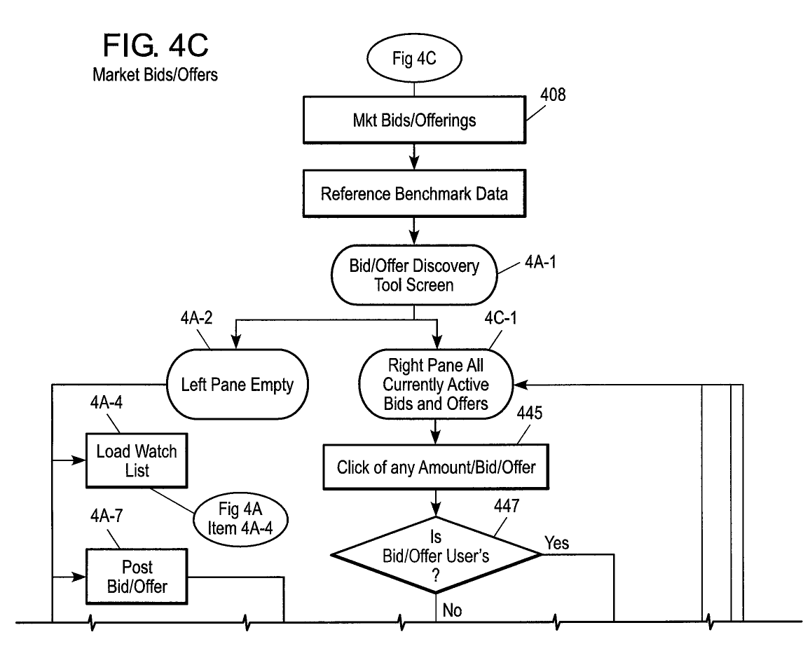

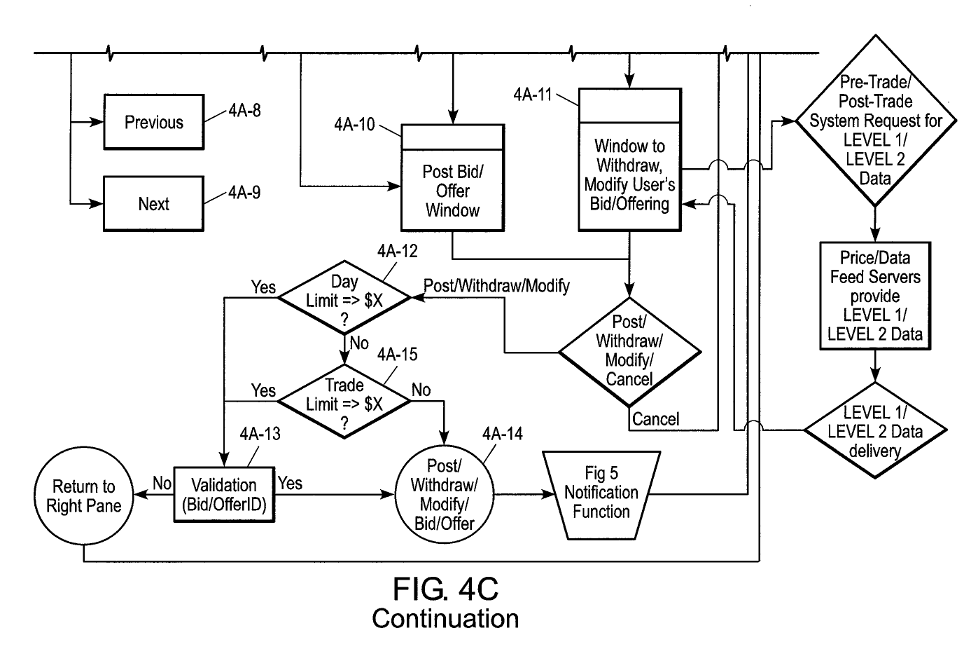

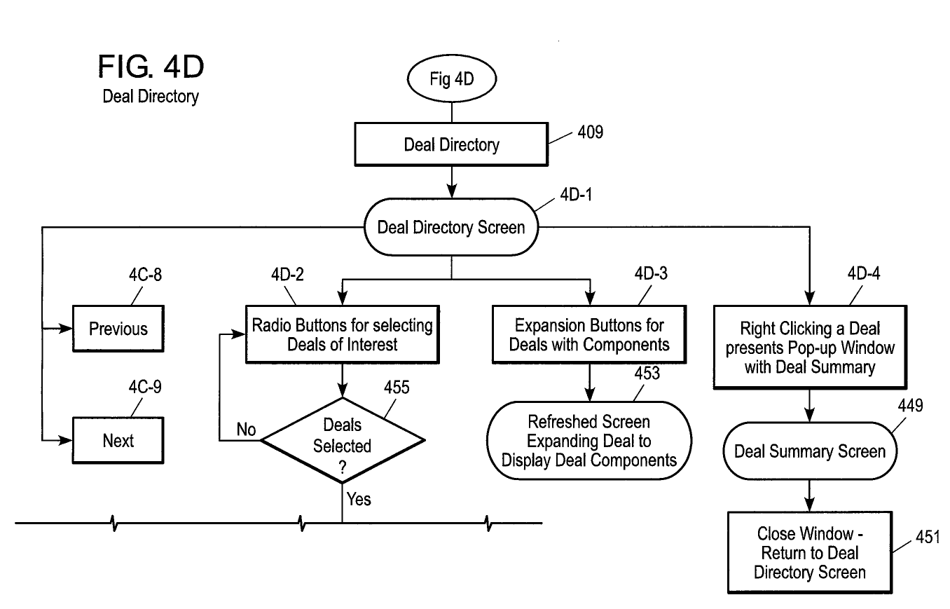

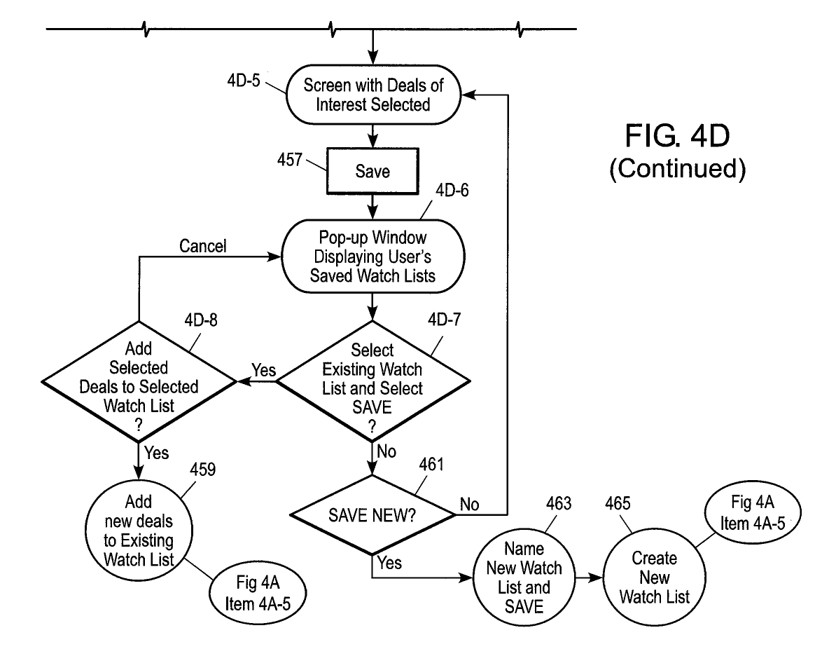

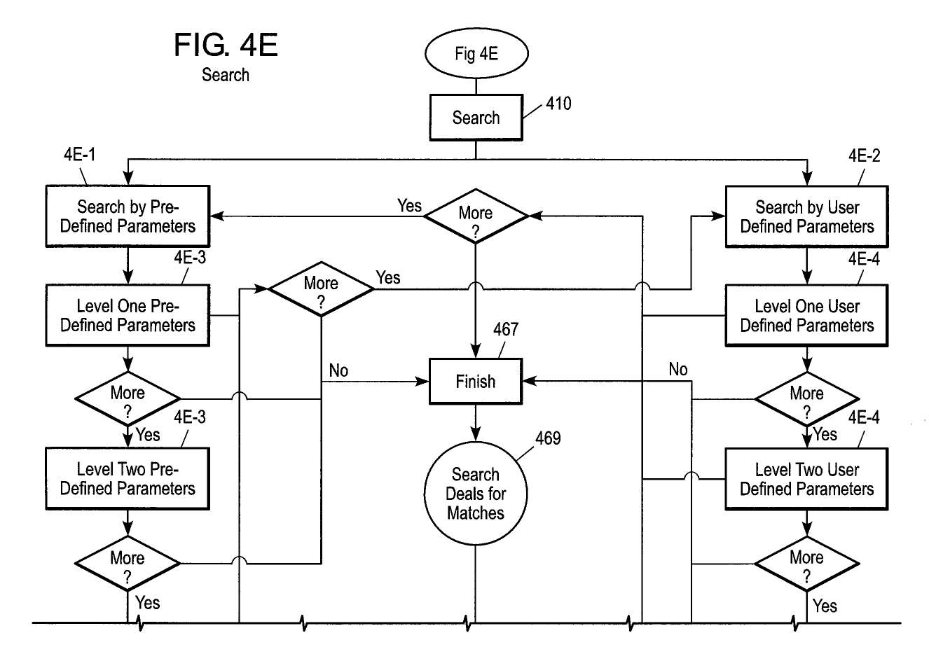

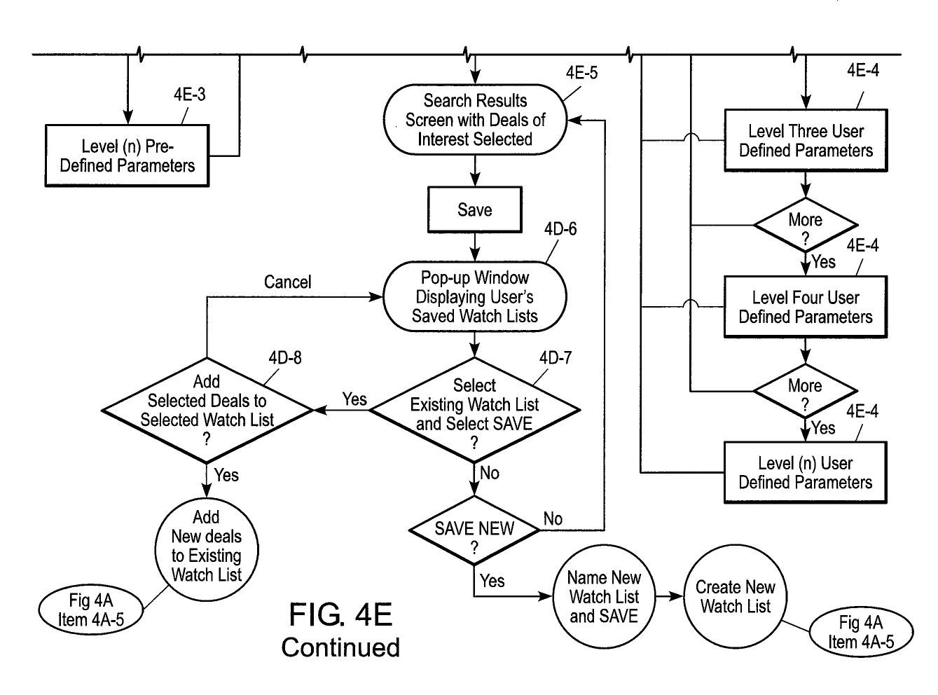

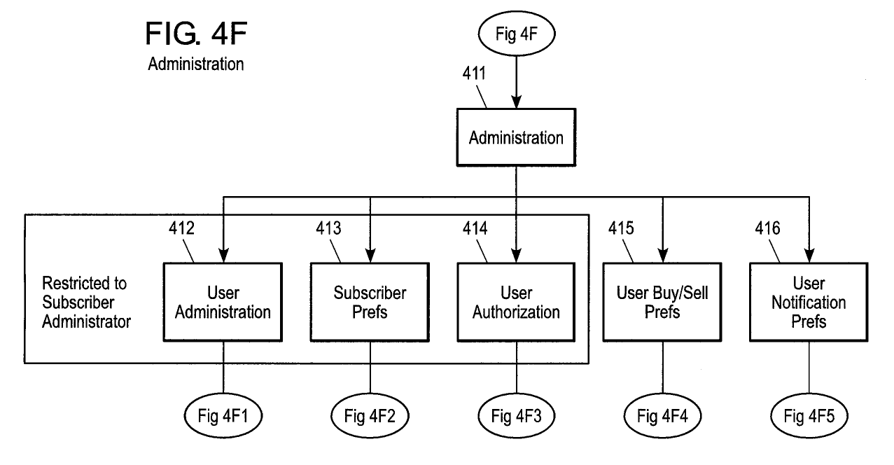

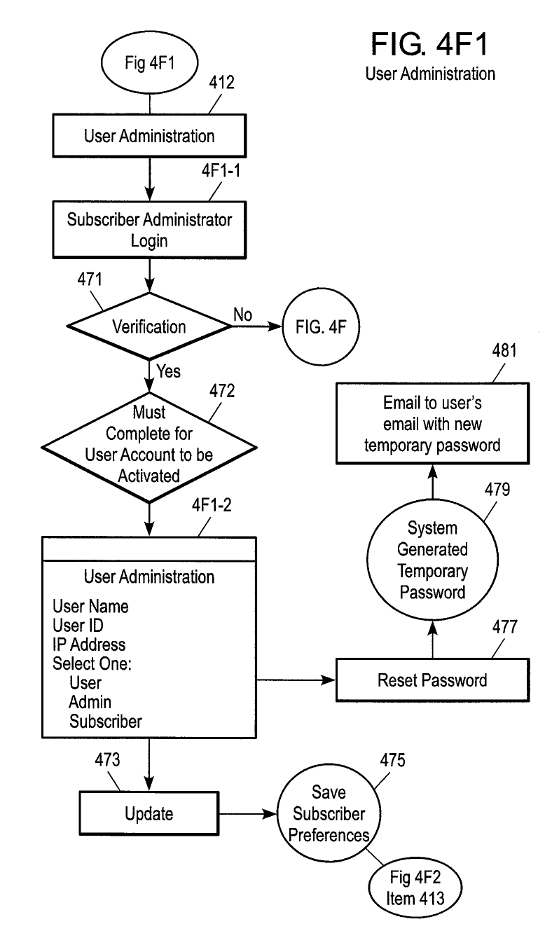

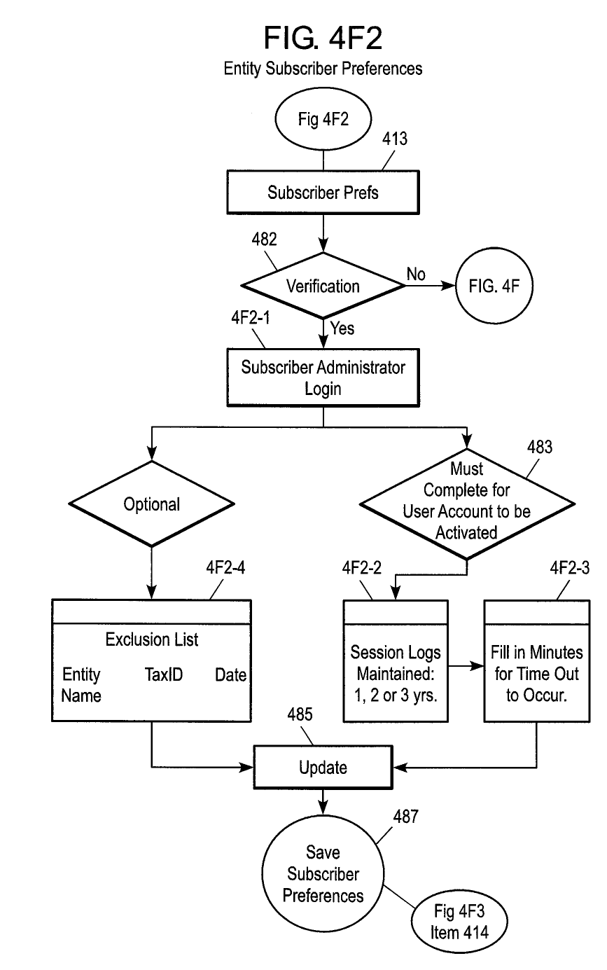

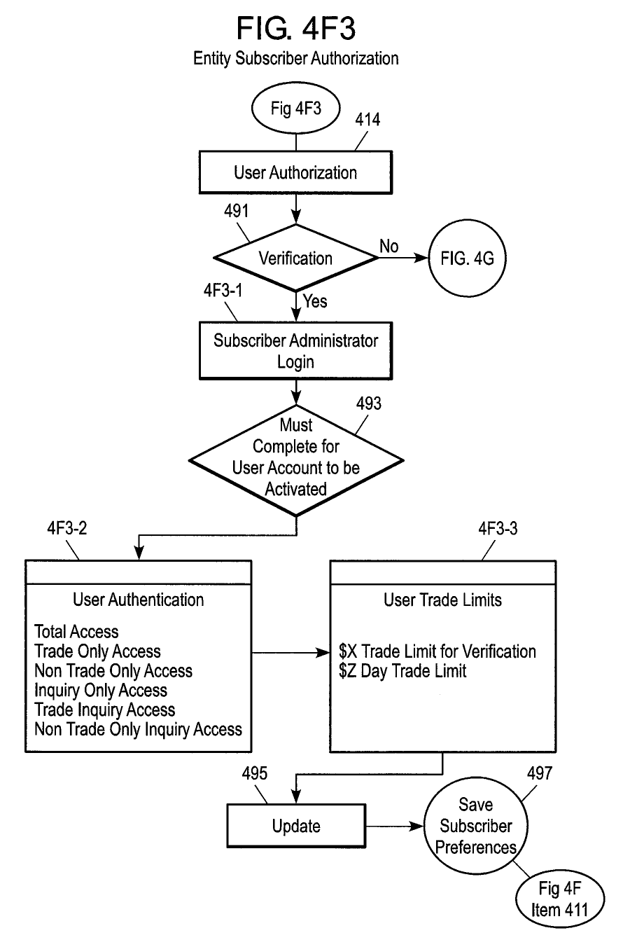

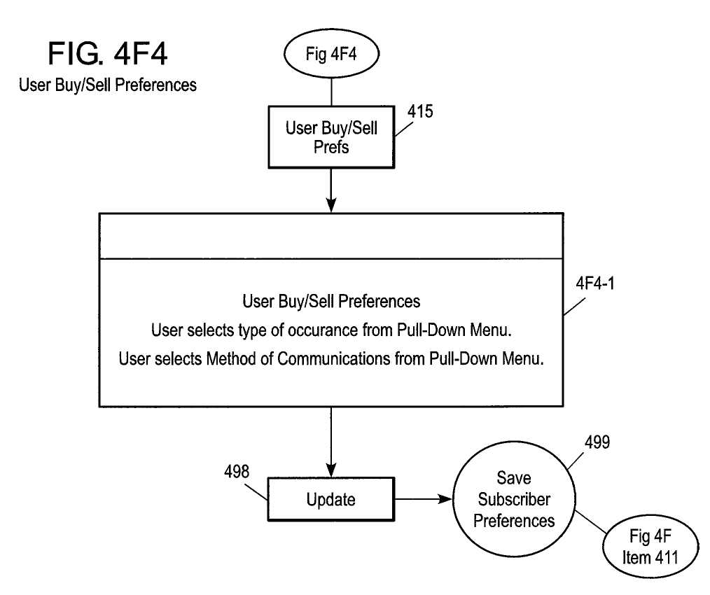

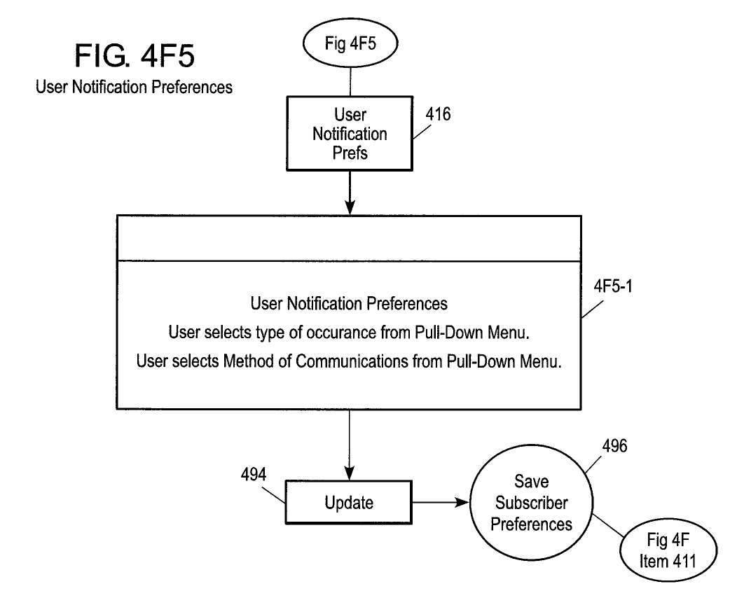

After accessing the home page 100, the user may be directed to a company home page option 117, which may take the user to a public website home page of the company 119. Alternatively, the user may be directed to an asset analytic 1A, which may take the user to an asset analytic home page 121 as described in FIG. 3. Alternatively still, the user may be directed to an asset access 1B, which may take the user to an asset access home page 123 as described in FIG. 4.

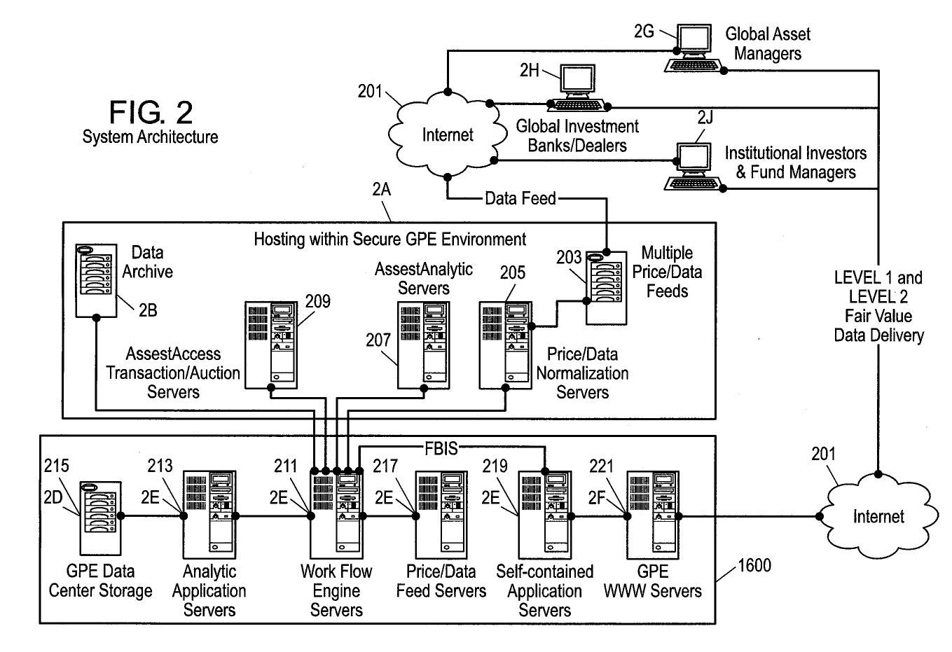

FIG. 2 is an exemplary schematic of system architecture. The integrated trading and information system may be structured to operate through computer software and hardware. The methods of the integrated trading and information system may be hosted within a secure environment 2A operated by a central organization. The hosting 2A may communicate by data feed via the Internet 201 with one or more of global asset managers 2G, global investment banks/dealers 2H, and/or institutional investors and fund managers 2J. The data feeds may enter the hosting 2A at a storage unit for receiving multiple price/data feeds 203. The storage unit 203 may be in communication with one or more price/data normalization servers 205. The hosting 2A may further include asset analytic servers 207, asset access transaction/auction servers 209 and/or a data archive 2B. The storage unit 203, asset analytic servers 207, asset access transaction/auction servers 209 and/or a data archive 2B may be in communication with a financial business intelligence system (FBIS) 1600. Communications with the hosting 2A may occur at a work flow engine server 211. The work flow engine server 211 may preferably be in communication 2E in series with one or more analytic application servers 213 and/or data center storage 215. The work flow engine server 211 may also be in communication with one or more price/data feed servers 217. The work flow engine server 211 may further be in communication with one or more self-contained application servers 219, which may be in communication 2F with World Wide Web servers 221. The World Wide Web servers 221 may communicate via the Internet 201 with asset analytic servers 207, asset access transaction/auction servers 209 and/or a data archive 2B.

FIG. 3 is an exemplary flow diagram of an analytic module home page. A user may access a home page 300-1. From the home page, the user may access a demonstration 307. Alternatively, the user may be directed to request registration 301. An offline approval and/or contracting process 309 may be contacted for approval 311. If approved, an email with approval information 303 may be sent. If not approved, an email with a denial message 302 may be sent.

If a user is already registered, the user may proceed to a login screen 313. Login functionality is described in FIG. 8. Verification 304 may be requested. If a login is not accepted, the user is returned to the login screen 313. If accepted, the user is directed to select an asset category 305. The user may have access to a list of default and user's saved models 315. Asset categories may include distressed debt 317, private equity 319, CDO/CLO 321, ABS/Mortgage 323, and others 325. Based on a user's selection, an appropriate model is loaded 327.

FIG. 4 is an exemplary flow diagram of a trade module home page. A user may access a home page 100-2. From the home page, the user may access a demonstration 409. Alternatively, the user may be directed to request subscription 101. An offline approval and/or contracting process 113 may be contacted for approval 115. If approved, an email with approval information 103 may be sent. If not approved, an email with a denial message 102 may be sent.

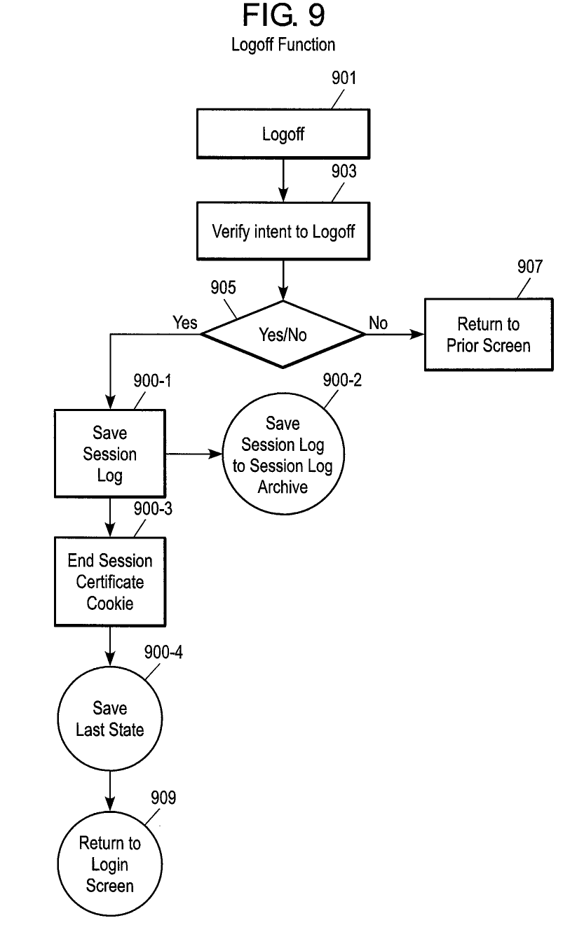

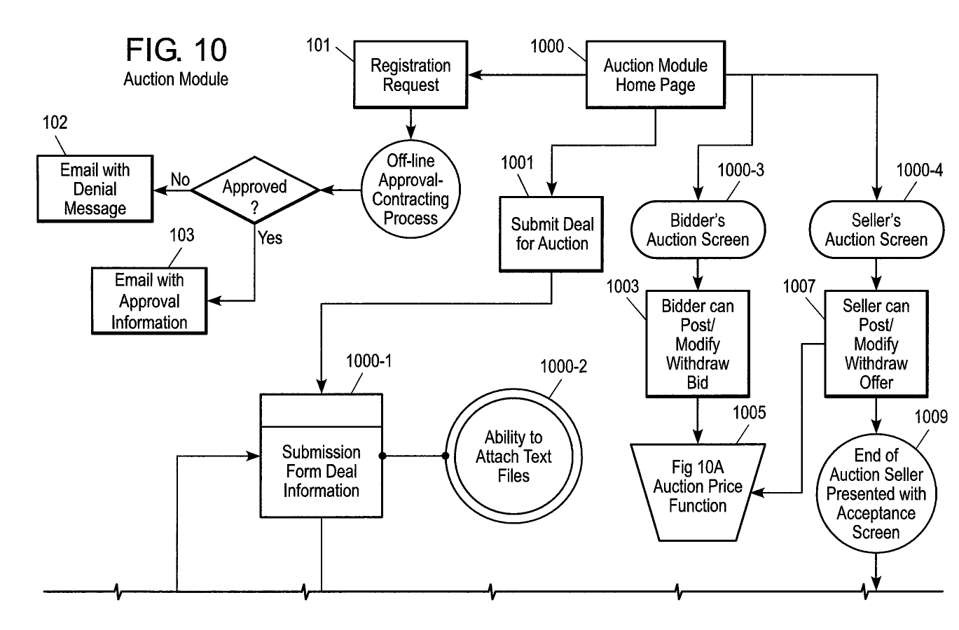

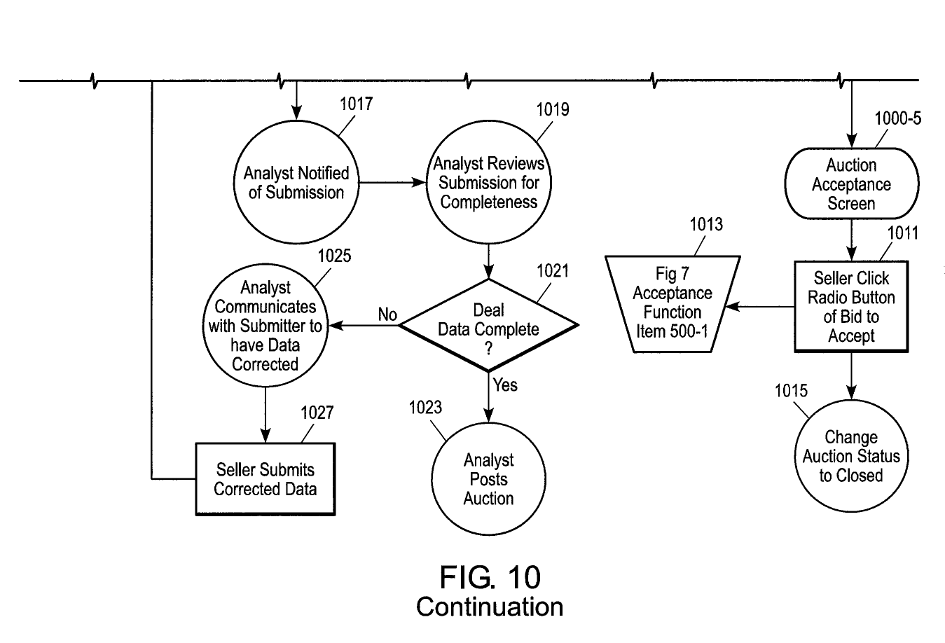

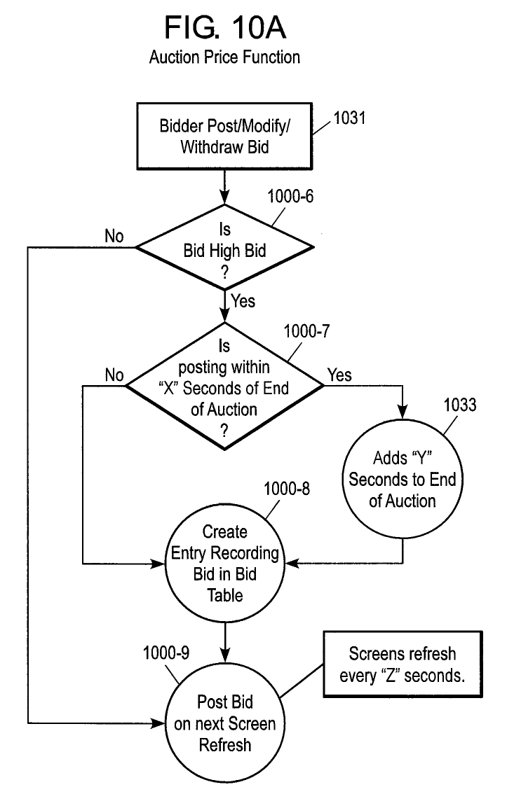

If a user is already registered, the user may proceed to a login screen 411. Login functionality is described in FIG. 8. Verification 104 may be requested. If a login is not accepted, the user is returned to the login screen 411. If accepted, the user is taken to select a menu screen 401. From the menu screen 401, the user may access the auction module 408 as shown in FIGS. 10 and 10A and/or logoff 410 as described in FIG. 9.

The user may also access a bid/offer discovery tool 402, as shown in FIG. 4A, a my bids/offerings screen 403, as shown in FIG. 4B, a market bids/offers screen 404, as shown in FIG. 4C, a deal directory 405, as shown in FIG. 4D, a search 406, as shown in FIG. 4E, and/or an administration screen 407, as shown in FIG. 4F.

FIG. 4A is an exemplary flow diagram of a bid/offer discovery page. The bid/offer discovery tool 402 may be accessed and interacted with via a bid/offer discovery tool screen 4A-1. Reference benchmark data 417 may be available. A pane 4A-3 may show an alpha list of all available deals. Another pane 4A-2 may show a watch list. The watch list may initially be empty, and may be populated by a user. A user may load a watch list 4A-4 by selecting a desired watch list 419. The system may determine 421 if the selected watch list is in the watch list pane 4A-2. If yes, then nothing is done 423. If no, the selected watch list populates 4A-5 the pane 4A-2. The user may then select a deal 425 and market depth for a product may populate 4A-6 the pane 4A-3.

The user may then click any amount/bid/offer 427. A determination 429 may be made if the bid/offer is a user's. If yes, the user is taken to a window to withdraw or modify the user's bid/offering 4A-11. The user may cancel and the system may access a pre-trade/post-trade system request for Level 1/Level 2 data 331. The system may then access price/data servers to provide Level 1/Level 2 data 433 and deliver the Level 1/Level 2 data.

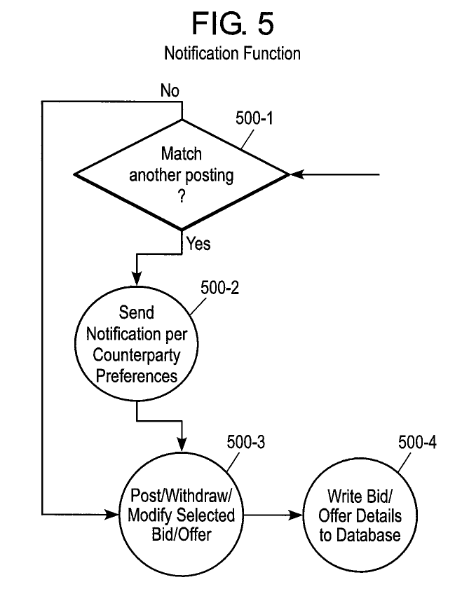

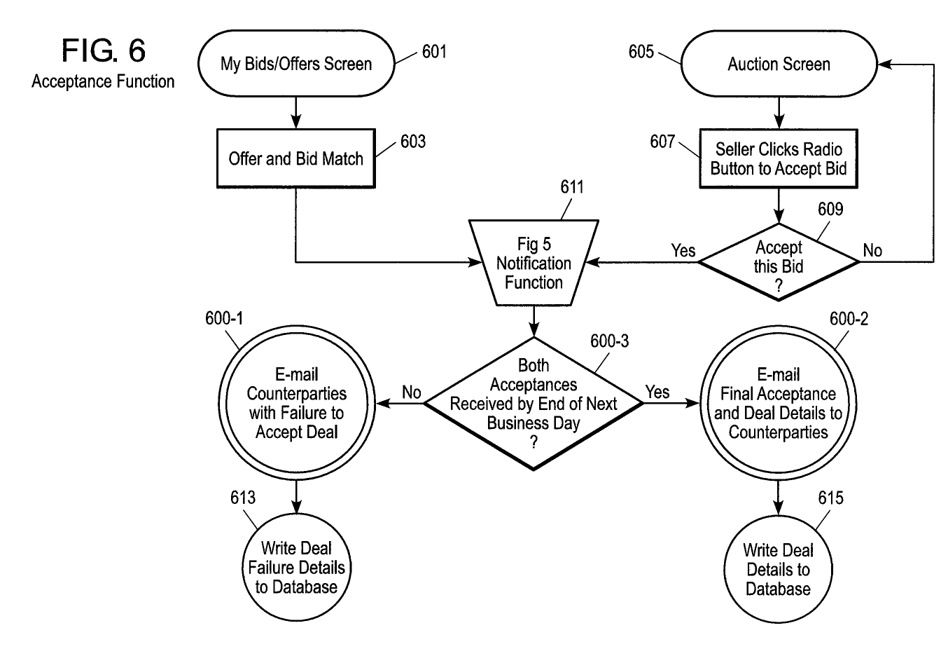

If the bid/offer is not a user's, the user may be directed to a post bid/offer window 4A-10. As an alternative route to the post bid/offer window 4A-10, the user may navigate to a post bid/offer selection 4A-7. After either the post bid/offer window 4A-10 or the window to withdraw 4A-11, a determination is made regarding posting/withdrawing/modifying or canceling 437. The user may be sent back to the market depth screen 4A-6 at this point. If a user decides to post/withdraw or modify, a determination is made whether a day limit has exceeded a threshold 4A-12. If no, a determination is made if the trade limit has exceeded a threshold 4A-15. If both thresholds have been exceeded, the user is taken to a post/withdraw/modify/bid/offer screen 4A-14. If both thresholds have not been exceeded, the user is taken to a validation (bid/offered) screen 4A-13, which may require a pass code. If not validated, the user may be returned to the alpha list 4A-3. If validated, the user may proceed to the post/withdraw/modify/bid/offer screen 4A-14. The system may then provide a notification function 439, as shown in FIG. 5. The user may then be returned to a market depth screen 4A-6. A user may be provided with “previous” 4A-8 and/or “next” options 4A-9.

FIG. 4B is an exemplary flow diagram of an individual's bid/offer page. From the bid/offer discovery tool screen 4A-1, a user may access a pane 4B-1 with a user's currently active bids and offers. The user may click to withdraw a bid 4B-2, which may bring up a prompt for a Y/N answer 441, or the user may click to withdraw an offer 4B-2, which may bring up a prompt for a Y/N answer 442. If either is answered yes, then a determination is made if a daily limit has been exceeded 4A-12 as described in FIG. 4A. The process steps then follow a similar pattern to those of FIG. 4A. If either prompt is answered no, or after a notification is issued, the user may be returned to the pane 4B-1.

Alternatively, from the pane 4B-1, the user may click any amount/bid/offer 443. The user may then be taken to a window to withdraw or modify the user's bid/offer 4A-11 as described in FIG. 4A. The process may then follow a similar pattern to those of FIG. 4A.

FIG. 4C is an exemplary flow diagram of market bids/offers page. From a market bids/offering screen 408, the user is taken to a bid/offer discovery tool screen 4A-1. Operation of the watch list pane 4A-2 may be substantially similar to that described in FIG. 4A. A pane 4C-1 for all currently active bids and offers may be accessed by the use rand the user may click any amount/bid/offer 445. A determination may be made whether the bid/offer is the user's 447. The process may then follow a similar pattern to FIG. 4A.

FIG. 4D is an exemplary flow diagram of a deal directory page. The deal directory 409 may provide access to a deal directory screen 4D-1. Previous 4C-8 and next 4C-9 functionality may be provided. Right clicking, for example, a deal may present a pop-up window or other indication with a deal summary 4D-4. The indication may include a deal summary window 449 that may be closed 451 to return to the deal directory screen 4D-1. Expansion buttons for deals with components 4D-3 may be provided. A refreshed screen 453 may expand a deal to display deal components.

Radio buttons or other similar devices 4D-2 may allow selection of deals of interest. A determination 455 may be made by the system if a deal has been selected. If yes, a screen of selected deals of interest may be provided 4D-5. The selections may be saved 457. A pop-up window or other indication 4D-6 may display a user's saved watch lists. A determination may be made whether an existing watch list has been selected along with a save operation 4D-7. If yes, a determination may be made whether to add the selected deals to the selected watch list 4D-8. If yes, new deals are added to the existing watch list 459. If it is determined that an existing list was not selected for a save, a determination may be made to save a new deal to the watch list 461. If no, the user may be returned to the screen with deals of interest 4D-5. If yes, the new watch list may be named and saved 463 and the new watch list may be created 465, as shown in FIG. 4A.

FIG. 4E is an exemplary flow diagram of a search page 410. A user may search either by predetermined parameters 4E-1 and/or user defined parameters 4E-2. The search parameters may be interchangeable and may interact at various stages. When searching by user defined parameters, parameters from level 1 to n may be used 4E-4. Similarly, when searching by predefined parameters, parameters from level 1 to n may be used 4E-3. When the search is completed 467, deals may be searched for matches 469. A search results screen 4E-5 may show selected deals of interest and may prompt for a save. The procedure for saving a deal of interest to a watch list is substantially similar to that of FIG. 4D.

FIG. 4F is an exemplary flow diagram of an administration page 411. Some options may be restricted to a subscriber administrator, such as user administration 412, as shown in FIG. 4F1, subscriber preferences 410, as shown in FIG. 4F2, and user authorization 414, as shown in FIG. 4F3. Other options may not be restricted, such as user buy/sell preferences 415, as shown in FIG. 4F4, and user notification preferences 416, as shown in FIG. 4F5.

FIG. 4F1 is an exemplary flow diagram of user administration page 412. A user may be directed to a subscriber administrator login with subsequent verification 471. If verification is denied, the user is taken to the system of FIG. 4F. If verification is authorized, a determination is made 473 if data is necessary for a user account to be activated 472. User administration 4F1-2 may include user name, user ID, IP address, and selection of user, administrator or subscriber. If updates are required 475, subscriber preferences may be saved according to FIG. 4F2. From user administration 4F1-2, a password may be reset 477, the system may generate temporary password 479, and the user may be emailed with the new temporary password 481.

FIG. 4F2 is an exemplary flow diagram of an entity subscriber preference page 413. Upon verification 482, the user may be directed to a subscriber administrator login 4F2-1. A determination may be made 483 if data is necessary for a user account to be activated 483. Session logs may be maintained for 1, 2 or 3 years 4F2-2. Minutes for time out to occur may be filled out 4F2-3. Optionally, an exclusion list may be determined 4F2-4. The system may be updated 485 and user preferences may be saved 487.

FIG. 4F3 is an exemplary flow diagram of an entity subscriber authorization page 414. After verification 489, the user may be directed to a subscriber administrator login 4F3-1. A determination may be made 491 if data is necessary for a user account to be activated 493. User authentication 4F3-2 may include total access, trade only access, non-trade only access, inquiry only access, trade inquiry access, and non-trade only inquiry access. User trade limits 4F3-3 may include trade limits for verification and/or day trade limits. The system may be updated 495 and user preferences may be saved 497.

FIG. 4F4 is an exemplary flow diagram of a user buy/sell preferences page 415. User buy/sell preferences 4F4-1 may include user selected type of occurrence from a pull-down or other type of menu and/or user selected methods of communication from a pull-down or other type of menu. The system may be updated 498 and user preferences may be saved 499.

FIG. 4F5 is an exemplary flow diagram of user notification preferences page 416. User notification preferences 4F5-1 may include user selected type of occurrence from a pull-down or other type of menu and/or user selected methods of communication from a pull-down or other type of menu. The system may be updated 494 and user preferences may be saved 496.

FIG. 5 is an exemplary flow diagram of a notification function. A determination may be made whether an item matches another posting 500-1. If yes, a notification may be sent per counterparty preferences 500-2. If no, or after the notification, a user may post/withdraw/modify a selected bid/offer 500-3. The bid/offer details may be written to a database 500-4.

FIG. 6 is an exemplary flow diagram of an acceptance function. From a bids/offers screen 601, an offer and bid match 603 may be selected. The system may then access the notification function 611 of FIG. 5. Alternatively, from an auction screen 605, a seller may select an accept bid indicator 607. A determination may be made whether the bid is accepted 609. If not, the user is returned to the auction screen. If yes, the system may access the notification function 611 of FIG. 5.

A determination may then be made whether both acceptances were received by the end of the next business day 600-3. If no, the system may notify counterparties with failure to accept the deal 600-1 and the deal failure details may be written to a database 613. If yes, the system may notify the counterparties with final acceptance and deal details 600-2 and the deal details may be written to a database 615.

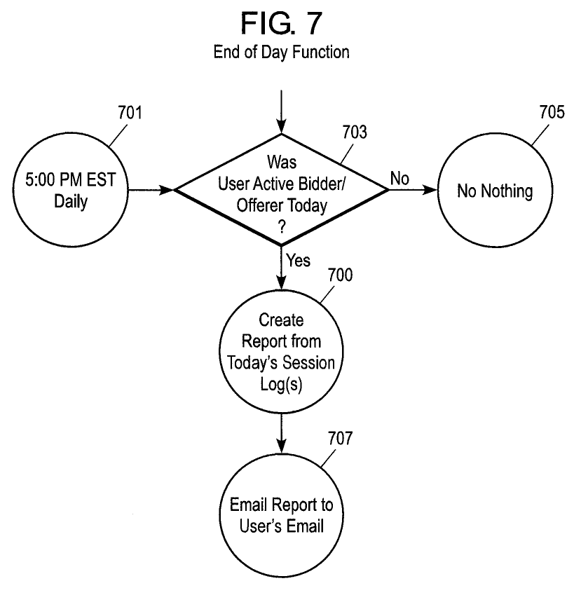

FIG. 7 is an exemplary flow diagram of an end of day function. At the close of business 701, a determination is made regarding whether the user was an active bidder/offerer that day 703. If no, nothing is done 705. If yes, a report of that day's session log(s) may be created 700. A notification may be sent to the user 707.

FIG. 8 is an exemplary flow diagram of a login function 801. The user may enter a user ID and/or password 803. A determination may be made of the validity of the user ID and/or password 805. If access is denied 807, a login error message 809 may be generated. Preferably, three attempts 811 may be allowed to login by returning to the login 801. On a third unsuccessful attempt and error message may be present that the account has been suspended and requesting the user contacts the user's administrator 813. The user ID may be locked out until the user administrator reactivates the user account. The subscriber administrator may initiate the system by reactivating the user account 815. The system may issue a temporary password and may notify the user 800-3. Similarly, if the user has forgotten the password 800-7, the system may issue a temporary password and notify the user 800-3. On the next login, the user may be forced to change the temporary password to a new password 800-2.

If validation is successful, access to the user account may be approved 815. User privileges may be assigned 800-3. A session certificate cookie may be issued 800-4. A session log may be opened 800-5. The system may check for a last state from a previous login 800-6. If no last state is found, the use may be directed to the system home page 817. If a last state is found, a determination may be made if the use would like the last state or a fresh session 819. If the user selects a fresh session, the user may be directed to a system home page 821. If the user selects the last state, the user may be presented with the last state 823.

FIG. 9 is an exemplary flow diagram of a logoff function 901. The system may verify the intent to log off 903. A determination may be made as to whether the user has selected yes or no 905. If no, the user may be directed to the previous screen 907. If yes, the system may save the session log 900-1 and the session log may be saved to a session log archive 900-2. The system may end the session certificate cookie 900-3. The system may save the last state 900-4. The system may return to the login screen 909.

FIG. 10 is an exemplary flow diagram of an auction module. A user may be presented with an auction module home page 1000. Registration requests may be processed as found in FIG. 1. From the auction module home page 1000, the user may select a seller's auction screen 1000-4, a bidder's auction screen 1000-3, and/or to submit a deal for auction 1001. From the bidder's auction screen 1000-3, the bidder may post/modify/withdraw a bid 1003. The system may then access the auction price function of FIG. 10A 1005. From the seller's auction screen 1000-4, the seller may post/modify/withdraw an offer 1007. The system may then access the auction price function of FIG. 10A 1005. Alternatively, at the end of an auction, the seller may be presented with an acceptance screen 1009 and/or an auction acceptance screen 1000-5. The seller may indicate an acceptance of a bid 1011. The system may access the acceptance function of FIG. 7 1013 and/or the auction status may be changed to closed 1015.

When submitting a deal for auction 1001, the user may access a submission form with deal information 1000-1. The submission form may include the ability to attach text or other types of files 1000-2. An analyst may be notified of the submission 1017 and the analyst may review the submission for completeness 1019. A determination may be made if the deal data is complete 1021. If yes, the analyst may post the auction 1023. If no, the analyst may communicate with the submitter to correct the data 1025. The seller may then submit corrected data 1027 via the submission form 1000-1.

FIG. 10A is an exemplary flow diagram of an auction price function. A bidder may post/modify/withdraw a bid 1031. A determination may be made whether the bid is a high bid 1000-6. If no, the bid may be posted on the next screen refresh 1000-9. A screen may refresh at a predetermined rate. If the bid is high, a determination may be made whether the bid was within a predetermined time of the end of the auction 1000-7. If yes, the system may add a predetermined amount of additional time of the end of the auction 1033. The system may create an entry recording the bid in a bid table 1000-8. If the bid is not within a predetermined time of the end of the auction, the system may create an entry recording the bid in a bid table 1000-8 without adding additional time to the auction. The bid may then be posted on the next screen refresh 1000-9.

The above-described exemplary embodiments of a system and method are presented for illustrative purposes only. While this invention is satisfied by embodiments in many different forms, it is understood that the present disclosure is to be considered as exemplary and is not intended to limit the described systems and methods to the specific embodiments illustrated and described herein. In view of this written description, numerous variations may be made by persons skilled in the art without departure from the spirit of this description. Moreover, features described in connection with one embodiment may be used in conjunction with other embodiments, even if not explicitly stated above. The scope of the invention will be measured by the appended claims and their equivalents. The summary, abstract and the title are not to be construed as limiting the scope of the claims, as their purpose is to enable the appropriate authorities, as well as the general public, to quickly determine the general nature of the described systems and methods. In the claims that follow, unless the term “means” is used, none of the features or elements recited therein should be construed as means-plus-function limitations pursuant to 35 U.S.C. §112, ¶6.

1. A system for automated trading comprising:
a processor coupled to a memory, the memory comprising computer-program instructions executable by the processor, the computer-program instructions, when executed by the processor, for performing operations of:
facilitating communications between one or more bidders and one or more offerors regarding one or more transactions for an asset,
facilitating communications between the one or more bidders and the one or more offerors regarding one or more auction deals for the asset,
price value indications for the asset, and
providing additional information regarding the asset through risk metrics and analytical tools, wherein the risk metrics and analytical tools accept input regarding a desired model and compute an output recommendation through one or more algorithms to assist in review of the asset.

2. The system of claim 1, further comprising monitoring the one or more transactions.

3. The system of claim 1, wherein the one or more transactions are simulated.

4. The system of claim 1, wherein the one or more auction deals are simulated.

5. The system of claim 1, wherein the price value indications are a synthetic fair value for the asset.

6. The system of claim 5, wherein the risk metric and analytical tool module provides a comparison of the synthetic fair value for the asset and actual trade values for the asset.

7. The system of claim 1, wherein the system communicates with one or more outside information sources via a network.

8. The system of claim 1, wherein the one or more outside information sources are selected from the group consisting of global asset managers, global investment banks, global investment dealers, institutional investors, institutional fund managers, and combinations thereof.

9. The system of claim 1, wherein the one or more bidders may withdraw or modify a bid prior to acceptance by the one or more sellers.

10. The system of claim 1, wherein the one or more bidders may withdraw or modify an offer prior to acceptance by the one or more buyers.

11. The system of claim 1, wherein an identity of the one or more bidders is confidential from the one or more sellers.

12. A method for determining a synthetic fair value comprising:
aggregating one or more inputs corresponding to an asset type from one or more external databases of financial information,
processing the one or more inputs corresponding to the asset type with one or more synthetic fair value models,
generating a synthetic fair value for the asset type from the one or more synthetic fair values, and
storing the synthetic fair value in a central database for dissemination to a user desiring the synthetic value for the asset type.

13. The method of claim 12, wherein the one or more inputs are observable market data.

14. The method of claim 12, wherein the asset type is selected from the group consisting of, unregistered securities, exempt securities, indices, derivatives, contracts, unlisted products, and combinations thereof.

15. The method of claim 12, wherein the synthetic fair value models are valuation algorithms or pricing models.

16. The method of claim 12, wherein the synthetic fair value models are selected from the group consisting of qualitative and quantitative-based judgments, observable market data algorithms, variable, and combinations thereof.

17. The method of claim 12, wherein the synthetic fair value is a Level 2 price as defined by the Financial Accounting Standards Board Rule 157, effective Nov. 15, 2007.

18. The method of claim 17, wherein the synthetic fair value is associated with a date and time of the generating of the synthetic fair value.

19. A system for providing a synthetic fair value comprising:
a central database comprising one or more synthetic fair values corresponding to one or more asset types,
wherein the one or more synthetic fair values are used to provide bid and offer market intelligence in response to an inquiry during trading or prior to trading on an automated trading system for the one or more asset types,
wherein the trading on the one or more asset types is not actively yielding actual trade information, and
wherein the synthetic fair value enables asset price discovery at the time and date of the inquiry.

20. The system of claim 19, wherein the synthetic fair value is a Level 2 price as defined by the Financial Accounting Standards Board Rule 157, effective Nov. 15, 2007.
